(19) United States
(12) Patent Application Publication
(10) Pub. No.: US 2002/0189616 A1
(43) Pub. Date: Dec. 19, 2002

(54) Oxygen mask

(76) Inventor: G. Thomas Wolf, Mason, OH (US)

Correspondence Address: NEAL O. WILLMANN, 9521 MONTGOMERY ROAD, CINCINNATI, OH, 45242, US

(21) Appl. No.: 09/834,208

(22) Filed: Apr. 13, 2001

(51) Int. Cl. A62B 18/02

(52) U.S. Cl. 128/205.25

(57) ABSTRACT

This disclosure relates to an oxygen mask having an improved means for quickly, safely and securely attaching the mask to the face of a patient. The improved means features a pair of adjustable elastic bands, each band affixed to one side of the mask, forming loops for extending from the sides of the mask and looping over each ear of the patient to form a snug fit over the patient's nose and mouth.

### BACKGROUND OF THE INVENTION

This invention relates to oxygen masks and an improved means and method for installing the masks on the faces of patients in need of oxygen. Oxygen masks are typically secured to the face of a patient with a length of elastic strap forming a single loop extending from one side of the mask, behind the patient's head and to the other side of the mask. This arrangement poses several problems, especially for emergency rescue personnel. First of all, extending the strap around the head can cause unnecessary flexion and movement of the neck, which is contraindicated in patients with potential cervical spine injury. Moreover, if manual traction is taken on the patient, it is not supposed to be released until the head is secured in a cervical immobilization device. Such a device makes applying the mask impossible without releasing traction. Secondly, the retention straps in current use are designed to be placed below the ears, and it is often difficult to maintain the mask in the proper position, especially when the patient is lying down with his or her head resting on a pillow. The strap, initially positioned properly between the head and the pillow, has a tendency to slip down to the rear of the patient's neck, and this can result in discomfort, mask slippage, and the delivery of inadequate concentrations of oxygen.

### DESCRIPTION OF THE PRIOR ART

The most relevant published prior art relating to the disclosed and claimed invention is U.S. Pat. No. 4,201,205, which issued to Bartholomew on May 6, 1980. It discloses what is characterized as an improved means for securing an oxygen mask to the face of the patient. Essentially, it comprises, in combination, non-elastic flexible tubing, which extends over and around the patient's ears and is brought under the chin where it is tightened by using an adjustable ring or clip; and a length of elastic tubing attached on opposite ends of the mask.

### SUMMARY OF THE INVENTION

Essentially, the improved means and method for securing an oxygen mask to the face of a patient can be defined as an oxygen mask having a novel means for attaching the mask to the patient's face, the improvement comprising: a pair of adjustable elastic bands, both ends of each pair affixed to each of both sides of said mask, said bands extendible to loop over and around the ears of the patient.

### BRIEF DESCRIPTION OF THE DRAWING

FIG. 1 is a perspective view of the disclosed oxygen mask attached to a patient's face by adjustable elastic loops extended around the patient's ears

FIG. 2 is an elevated frontal view of the oxygen mask disclosed herein depicting the improved means for attaching the mask to the patient's face.

### DESCRIPTION OF THE PREFERRED EMBODIMENT

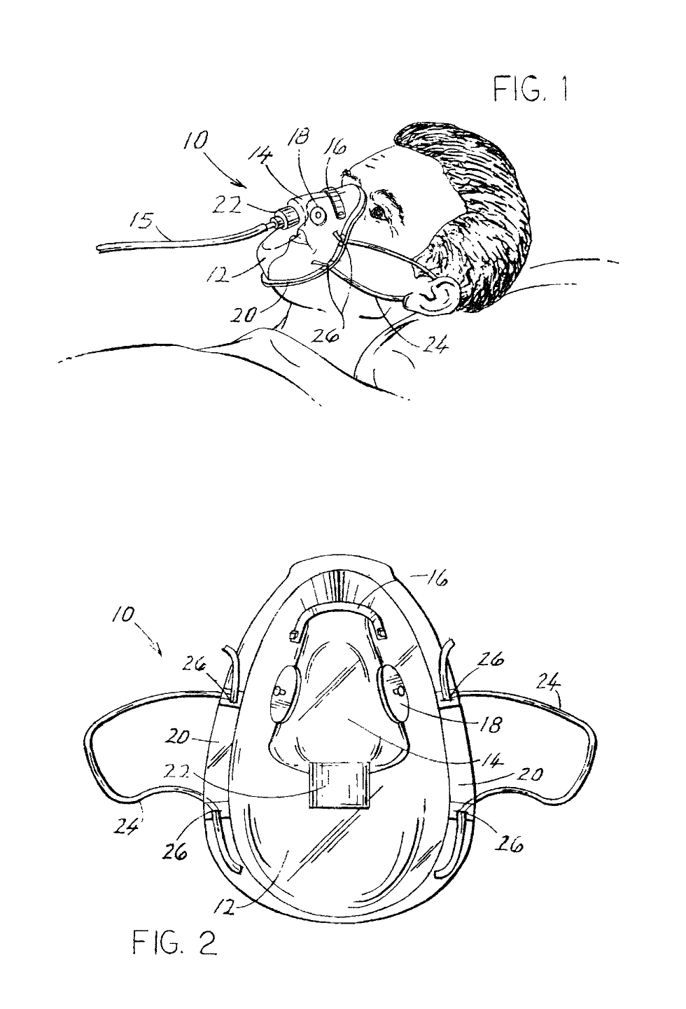

A full and complete understanding of the disclosed improvement can best be gained by referring to the drawing. FIGS. 1 and 2 are equally illustrative views of all the features of the preferred embodiment of the improvement. The mask 10 in its entirety can be readily comprehended and understood from FIG. 2. The mask is typically molded from plastic to form a soft, one-piece covering for the mouth and nose of the patient. The largest part of the mask 10 is the body 12, defined by a face-conforming periphery 20 and an enlargement to accommodate the nose 14. Attached to the nosepiece 14, in the vicinity of the nares or nostrils is the adapter plug 22 for the attachment of a tube 15 attached to an oxygen reservoir bag, air entrainment device, nebulizer, or other attachments (not shown) designed for the mask. Also on the nosepiece 14 are the exhalation ports, typically covered with a flap valve 18. A short metal strip 16, typically arching the bridge of the nose, is also found on most oxygen masks to enhance the fit on the particular patient's face.

The mask 10, while being fitted, is then secured to the patient's head by the adjustable elastic loops 24 that are preferably attached to the periphery 20 of the mask at two or four points of attachment 26. Clearly, each loop 24 could be secured to the mask at one point on each side of the mask, but experimental use thus far has weighed in on the side of two attachments on each side.

Looking again at FIG. 1, it should be apparent that the adjustable elastic loops 24 are intended to extend from the periphery 20 of the mask 10 to and around the patient's ears. Installation or attachment of the mask in this fashion can be done with no assistance, discomfort or movement on the part of the patient, and thus this mask and its loops are an improvement over any means of attachment currently available. Adjustment of the loops can be effected by simply pulling the loose ends secured at points 26, anteriorally.

While the foregoing is a complete and detailed description of the preferred embodiment of the disclosed method and means for attaching and securing an oxygen mask to the face of a patient, it should be apparent that numerous variations and modifications can be made and employed to implement the all-important purpose of the improved attachment means without departing from the spirit of the invention, which is fairly defined by the appended claims.

1. An oxygen mask having an improved means for being secured over the nose and mouth of a patient, the improvement comprising: a pair of elastic bands, both ends of each pair affixed to each of both sides of said mask, said bands extendible to loop over and around each ear of the patient.

2. The oxygen mask according to claim 1 wherein the elastic bands are affixed at four separate points on the mask.

3. The oxygen mask according to claim 1 wherein the elastic bands are affixed at two separate points on the mask.

4. The oxygen mask according to claim 1 wherein the elastic bands are adjustable.
